(19) United States
(12) Patent Application Publication
(10) Pub. No.: US 2025/0231849 A1
(43) Pub. Date: Jul. 17, 2025

(54) MEMORY CONTROLLER, SOLID-STATE STORAGE DEVICE, AND METHOD FOR MONITORING TEMPERATURE INFORMATION THEREOF

(71) Applicant: SILICON MOTION INC., Zhubei City (TW)

(72) Inventor: Chun-Cheng LEE, Zhubei City (TW)

(21) Appl. No.: 18/824,678

(22) Filed: Sep. 4, 2024

(30) Foreign Application Priority Data
Jan. 17, 2024 (TW) 113101796

(51) Int. Cl. G06F 11/30; G06F 13/40

(52) U.S. Cl. CPC G06F 11/3058; G06F 11/3075; G06F 13/4045

(57) ABSTRACT

A method for monitoring temperature information of a solid-state storage device is provided. The method includes the following steps: utilizing a first thermal sensor disposed on a PCIe physical layer and a second thermal sensor disposed on a flash memory control circuit to detect first temperature information of the PCIe physical layer of a memory controller and second temperature information of the flash memory control circuit, respectively; utilizing a temperature-information calculating circuit to calculate average temperature information of the memory controller within a predetermined period according to the first and second temperature information; utilizing the temperature-information calculating circuit to load the average temperature information into a register of a PCIe media access control (MAC) layer in response to a configuration read packet from a host; and utilizing the PCIe MAC layer to report the average temperature information stored in the register to the host through the PCIe bus.

### CROSS REFERENCE TO RELATED APPLICATION

The present application is based on, and claims priority from Taiwan Application Ser. No. 113101796, filed Jan. 17, 2024, the disclosure of which is hereby incorporated by reference herein in its entirety.

### BACKGROUND OF THE DISCLOSURE

### 1. Field of the Disclosure

The present disclosure relates to an integrated circuit, and in particular, to a memory controller, a solid-state storage device, and a method for monitoring temperature information thereof.

### 2. Description of the Related Art

In today's computer systems, a host and a solid-state storage device can be electrically connected to each other through a Peripheral Component Interconnect Express (PCIe) bus. Although data transmission between the host and the conventional solid-state storage device can be performed through the PCIe bus, the conventional solid-state storage device often needs to use other buses other than the PCIe bus to transmit temperature information of one or more components, which is detected by a thermal sensor in the solid-state storage device, to the host in real time. This approach not only increases complexity and manufacturing costs of circuit design and maintenance, but also may cause the host to misjudge the temperature information.

### SUMMARY

Therefore, the present disclosure provides a memory controller, a solid-state storage device, and a method for monitoring temperature information thereof to resolve the foregoing problems.

An aspect of the present disclosure provides a memory controller. The memory controller includes a Peripheral Component Interconnect Express (PCIe) physical layer, a PCIe media access control (MAC) layer, a Non-Volatile Memory Express (NVMe) conversion circuit, a flash memory control circuit, and a temperature-information calculating circuit. The PCIe physical layer is configured to electrically connect the memory controller to a host through a PCIe bus. The PCIe physical layer includes a first thermal sensor, configured to detect first temperature information of the PCIe physical layer. The PCIe MAC layer is electrically connected to the PCIe physical layer, and configured to convert an access command from the host into a PCIe signal. The NVMe conversion circuit is configured to convert the PCIe signal from the PCIe MAC layer into an NVMe signal. The flash memory control circuit is configured to control data access of the flash memory according to the NVMe signal. The flash memory control circuit includes a second thermal sensor, configured to detect second temperature information of the flash memory control circuit. The temperature-information calculating circuit is configured to calculate average temperature information of the memory controller within a predetermined period according to the first temperature information and the second temperature information. In response to a configuration read packet from the host, the temperature-information calculating circuit loads the average temperature information into a register of the PCIe MAC layer, and the PCIe media access control layer reports the average temperature information stored in the register to the host through the PCIe bus.

Another aspect of the present disclosure provides a method for monitoring temperature information of a solid-state storage device. The solid-state storage device is electrically connected to a host through a Peripheral Component Interconnect Express (PCIe) bus. A memory controller of the solid-state storage device includes a PCIe physical layer, a PCIe media access control (MAC) layer, a flash memory control circuit, and a temperature-information calculating circuit. The method includes the following steps: utilizing a first thermal sensor disposed on the PCIe physical layer and a second thermal sensor disposed on the flash memory control circuit to detect first temperature information of the PCIe physical layer of the memory controller and second temperature information of the flash memory control circuit, respectively; utilizing the temperature-information calculating circuit to calculate average temperature information of the memory controller according to the first temperature information and the second temperature information; utilizing the temperature-information calculating circuit to load the average temperature information into a register of the PCIe media access control layer in response to a configuration read packet from the host; and utilizing the PCIe MAC layer to report the average temperature information stored in the register to the host through the PCIe bus.

Yet another aspect of the present disclosure provides a solid-state storage device, which includes a flash memory and a memory controller. The memory controller includes a PCIe physical layer, a PCIe media access control (MAC) layer, a Non-Volatile Memory Express (NVMe) conversion circuit, a flash memory control circuit, and a temperature-information calculating circuit. The PCIe physical layer is configured to electrically connect the memory controller to a host through a PCIe bus. The PCIe physical layer includes a first thermal sensor, configured to detect first temperature information of the PCIe physical layer. The PCIe MAC layer is electrically connected to the PCIe physical layer, and configured to convert an access command from the host into a PCIe signal. The NVMe conversion circuit is configured to convert the PCIe signal from the PCIe media access control layer into an NVMe signal. The flash memory control circuit is configured to control data access of the flash memory according to the NVMe signal. The flash memory control circuit includes a second thermal sensor, configured to detect second temperature information of the flash memory control circuit. The temperature-information calculating circuit is configured to calculate average temperature information of the memory controller within the predetermined period according to the first temperature information and the second temperature information. In response to a configuration read packet from the host, the temperature-information calculating circuit loads the average temperature information into a register of the PCIe MAC layer. The PCIe MAC layer reports the average temperature information stored in the register to the host through the PCIe bus.

### BRIEF DESCRIPTION OF THE DRAWINGS

FIG. 1 is a block diagram of a computer system according to an embodiment of the present disclosure.

FIG. 2A is a block diagram of a temperature-information calculating circuit according to an embodiment of FIG. 1 of the present disclosure.

FIG. 2B is a schematic diagram of a temperature-information calculating circuit according to the embodiment of FIG. 2A.

FIG. 3 is a diagram of a PCIe configuration space of a solid-state storage device according to an embodiment of the present disclosure.

FIG. 4 is a diagram of a manufacturer capability structure according to an embodiment of the present disclosure.

FIG. 5 is a flowchart of a host obtaining average temperature information of a memory controller according to an embodiment of the present disclosure.

FIG. 6 is a block diagram of a computer system according to another embodiment of the present disclosure.

FIG. 7 is a flowchart of a method for monitoring temperature information of a solid-state storage device according to an embodiment of the present disclosure.

### DETAILED DESCRIPTION

The following description is preferred implementations for completing the disclosure and is intended to describe the basic spirit of the present disclosure, but is not intended to limit the present disclosure. The actual content of the disclosure needs to be referred to the scope of the patent application that follows.

It should be understood that terms such as “include” and “comprise” in the specification are used to indicate the presence of particular technical features, values, method steps, job processing, elements, and/or components, but do not exclude the addition of more other technical features, values, method steps, job processing, elements, components, or any combination thereof.

The use of terms such as “first”, “second”, and “third” in the scope of the patent application are used to modify the elements in the scope of the patent application, and are not used to indicate an order of priority or a precedence relationship between the elements, or a chronological order in execution of the method steps, but are only used to differentiate between elements with the same name.

The term “configured to” may describe or claim that various units, circuits, or other components are “configured to” perform one or more tasks. In such contexts, the term “configured to” is used to imply a structure by indicating that units/circuits/components include a structure (for example, a circuit system) that performs other (one or more) tasks during operation. Therefore, even when a specified unit/circuit/component does not currently operate (for example, is not turned on), it may still be described that the unit/circuit/component is configured to perform the task. Such units/circuits/components used in conjunction with the term “configured to” include hardware, for example, circuits and memories (storing program instructions that can be executed to perform an operation). In addition, the term “configured to” may include a generic structure (for example, a general-purpose circuit system) that is manipulated by using software and/or firmware (for example, an FPGA or a general-purpose processor that executes the software), to operate in a manner capable of executing the (one or more) task to be resolved. The term “configured to” may also include adapting a manufacturing program (for example, a semiconductor manufacturing device) to manufacture a device (for example, an integrated circuit) that is adapted to implement or perform one or more tasks.

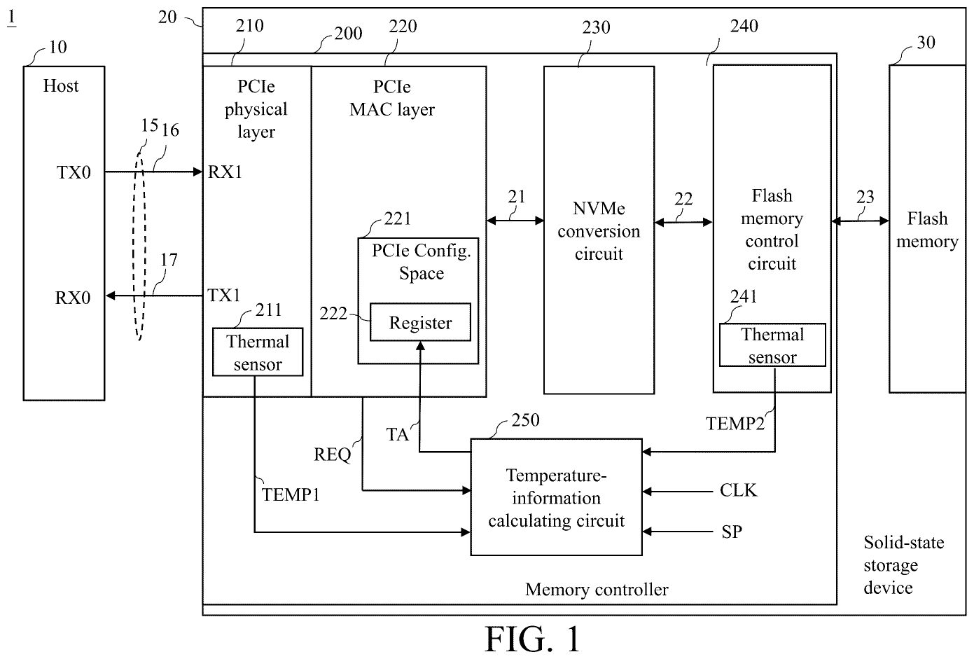

FIG. 1 is a block diagram of a computer system according to an embodiment of the present disclosure.

As shown in FIG. 1, a computer system 1 includes a host 10 and a solid-state storage device 20, and the host 10 is electrically connected to a solid-state storage device 20 through PCIe bus 15. In other words, the host 10 and the solid-state storage device 20 may perform data transmission through links 16 and 17 of PCIe bus 15. The link 16 is, for example, from a transmitter terminal TX0 of the host 10 to a receiver terminal RX1 of the solid-state storage device 20. The link 17 is, for example, from a transmitter terminal TX1 of the solid-state storage device 20 to a receiver terminal RX0 of the host 10.

In some embodiments, the solid-state storage device 20 may include a memory controller 200 and a flash memory 30. The memory controller 200 may be electrically connected to the flash memory 30, and configured to control data access of the flash memory 30. The memory controller 200 is, for example, an integrated circuit, supporting a PCIe protocol and a Non-Volatile Memory Express (NVM Express, NVME). The flash memory 30 is, for example, a NAND flash memory. The memory controller 200 includes a PCIe physical layer 210, a PCIe media access control (MAC) layer 220, an NVMe conversion circuit 230, a flash memory control circuit 240, and a temperature-information calculating circuit 250. The PCIe physical layer 210 may include a physical interface configured for data transmission, for example, the transmitter terminal TX1 and the receiver terminal RX1. The PCIe media access control layer 220 is, for example, a collective term for various circuits and registers with different functions, including a PCIe configuration space 221 and other general control circuits (not shown). The PCIe media access control layer 220 may convert a control signal and data of the host 10 received by the PCIe physical layer 210 through link 16 into a PCIe signal 21. The NVMe conversion circuit 230 is configured to convert the PCIe signal 21 from the PCIe MAC layer 220 into an NVMe signal 22, or convert an NVMe signal 22 from the flash memory control circuit 240 into a PCIe signal 21. The flash memory control circuit 240 is configured to generate a flash memory interface signal 23 according to the NVMe signal 22, to control data access of the flash memory 30. The temperature-information calculating circuit 250 is, for example, configured to calculate average temperature information TA of the memory controller 200 according to temperature information TEMP1 detected by a thermal sensor 211 and temperature information TEMP2 detected by a thermal sensor 241, the details of which will be described later.

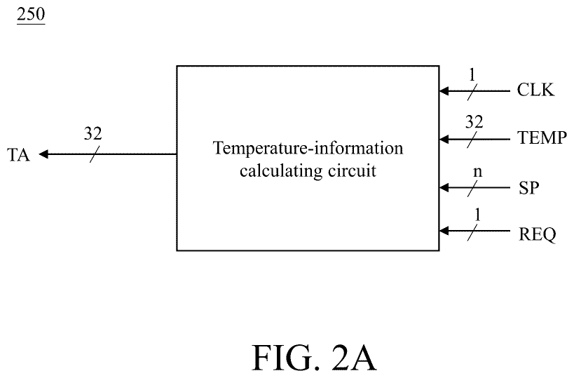

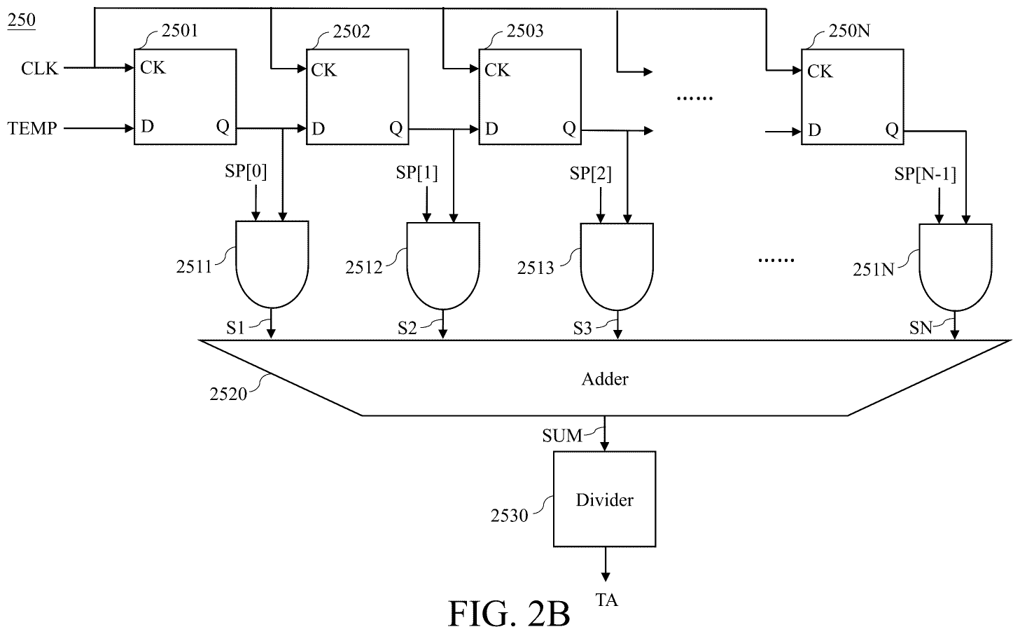

FIG. 2A is a block diagram of a temperature-information calculating circuit according to an embodiment of FIG. 1 of the present disclosure. FIG. 2B is a schematic diagram of a temperature-information calculating circuit according to the embodiment of FIG. 2A.

In some embodiments, as shown in FIG. 2A, input signals of the temperature-information calculating circuit 250 may include a clock signal CLK, a sampling period signal SP, a request signal REQ, and temperature information TEMP, and an output signal of the temperature-information calculating circuit 250 is the average temperature information TA of the memory controller 200 (or the solid-state storage device 20). A value on an arrow of each signal indicates the width (a number of bits) of the signal. For example, the clock signal CLK and the request signal REQ are signals of 1 bit, and the sampling period signal SP is a signal of N bits, and may be, for example, expressed as SP [N-1:0]. In some embodiments, the temperature information TEMP1 detected by the thermal sensor 211 and the temperature information TEMP2 detected by the thermal sensor 241 are, for example, both numerical values of 16 bits, and the temperature information TEMP is a 32-bit numerical value obtained by merging the temperature information TEMP1 and the temperature information TEMP2. The average temperature information TA of the memory controller 200 outputted by the temperature-information calculating circuit 250 is also a 32-bit numerical value.

Referring to FIG. 2B, the temperature-information calculating circuit 250 may include N D flip flops (DFF) 2501 to 250N, N AND gates 2511 to 251N, an adder 2520, and a divider 2530, where N is a positive integer. Each of the D flip flops 2501 to 250N includes a clock input end CK, a data input terminal D and a data output terminal Q. The D flip flops 2501 to 250N are connected in series to form a delay chain. For example, the data output terminal Q of the D flip flop 2501 is connected to the data input terminal D of the D flip flop 2502, the data output terminal Q of the D flip flop 2502 is connected to the data input terminal D of the D flip flop 2503, and so on. It should be noted that the width N (i.e., N bits) of the sampling period signal SP is the same as the number N of the D flip flops 2501 to 250N and the number N of the AND gates 2511 to 251N.

The data output terminal Q of each of the D flip flops 2501 to 250N is connected to one input terminal of a corresponding AND gates 2511 to 251N. In addition, the other input terminal of each of the AND gates 2511 to 251N receives a corresponding bit of the sampling period signal SP. For example, the AND gate 2511 receives the least significant bit (e.g., SP [0]) of the sampling period signal SP, the AND gate 2512 receives the second least significant bit (e.g., SP [1]) of the sampling period signal SP, and so on. The AND gates 2511 to 251N may generate individual temperature signals S1 to SN, and the adder 2520 may sum up the temperature signals S1 to SN to obtain a sum value SUM. The divider 2530 divides the sum value SUM by a valid number M, where the valid number M is equal to a number of bits in the sampling period signal SP that are equal to 1.

The following examples illustrates the operation of the temperature-information calculating circuit 250 by using several examples. In Examples 1 to 3, it is assumed that the period length of the clock signal CLK is 1 ms, and the number N is 8, indicating that the temperature-information calculating circuit 250 includes 8 D flip flops, which can form a delay chain with a delay of 8 ms, to record temperature information in 8 clock periods. In addition, the width of the sampling period signal SP is 8 bits, and it can be represented by SP [7:0].

In Example 1, the sampling period signal SP [7:0] is set to a binary value of 1111_1111, and the valid number M=8. For these eight valid sampling points, the sampling interval between two adjacent valid sampling points is 1 ms. In other words, the temperature-information calculating circuit 250 uses 1 ms as the sampling interval, and calculates the average temperature information TA of the memory controller 200 within 8 ms.

In Example 2, the sampling period signal SP [7:0] is set to a binary value of 1010_1010, and the valid number M=4. For these four sampling valid sampling points, the sampling interval between two adjacent valid sampling points is 2 ms. In other words, the temperature-information calculating circuit 250 uses 2 ms as the sampling interval, and calculates the average temperature information TA of the memory controller 200 within 8 ms.

In Example 3, the sampling period signal SP [7:0] is set to a binary value of 1000_1000, and the valid number M=2. The sampling interval between these two valid sampling points is 4 ms. In other words, the temperature-information calculating circuit 250 uses 4 ms as the sampling interval, and calculates the average temperature information TA of the memory controller 200 within 8 ms.

In Examples 4 and 5, it is assumed that the clock cycle of the clock signal CLK is 1 ms, and a number N=16, indicating that the temperature-information calculating circuit 250 includes 16 D flip flops, which may form a delay chain with a delay of 16 ms, to record temperature information within 16 clock cycles. In addition, the width of the sampling period signal SP is also 16 bits, and it can be represented by SP [15:0].

In Example 4, the sampling period signal SP [15:0] is set to a binary value of 1111_1111_1111_1111, and the valid quantity M=16. For these 16 sampling valid sampling points, the sampling interval between two adjacent valid sampling points is 1 ms. In other words, the temperature-information calculating circuit 250 uses 1 ms as the sampling interval, and calculates the average temperature information TA of the memory controller 200 within 16 ms.

In Example 5, the sampling period signal SP [15:0] is set to a binary value of 1000_1000_1000_1000, and the valid number M=4. For the 4 sampling valid sampling points, the sampling interval between two adjacent valid sampling points is 4 ms. In other words, the temperature-information calculating circuit 250 uses 4 ms as the sampling interval, and calculates the average temperature information TA of the memory controller 200 within 16 ms.

In some embodiments, when the sampling interval between two adjacent valid sampling points is M clock periods, there will be (M-1) zeros between two adjacent valid bits (e.g., bit value=1) in the sampling period signal SP, where M is a positive integer and M<N. For example, in Example 1, the sampling interval between two valid sampling points is 1 ms=1 clock cycle (e.g., M=1). In this case, the sampling period signal SP [7:0] is a binary value of 1111_1111, indicating that there is no zero between two adjacent bits that are equal to 1 (e.g., M-1=0). In Example 3, the sampling interval between two valid sampling points is 4 ms=4 clock cycles (e.g., M=4). In this case, the sampling period signal SP [7:0] is a binary value of 1000_1000, indicating that there are three zeros between two bits that are equal to 1 (e.g., M-1=3).

In some embodiments, when calculating the sum value SUM of the temperature signals S1 to SN, the adder 2520 separately sums up the first half (e.g., upper half including the 16 most significant bits) and the second half (e.g., lower half including the 16 least significant bits) of the temperature signals S1 to SN, to obtain the sum value SUM. That is, the first half and the second half of the sum value SUM represent the sum value of the temperature information TEMP1 and the sum value of the temperature information TEMP2, respectively. Therefore, the average temperature information TA calculated by the divider 2530 also includes the first half and the second half, representing the average value of the temperature information TEMP1 and the average value of the temperature information TEMP2, respectively.

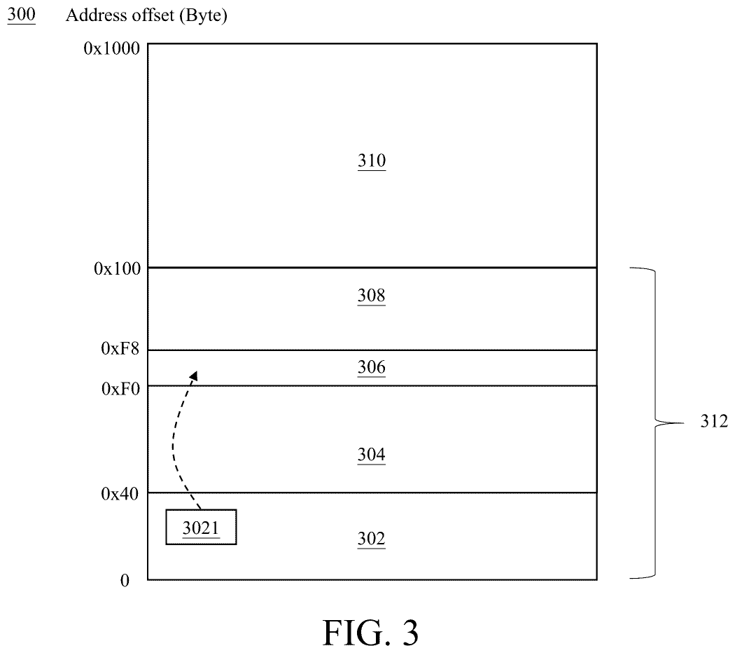

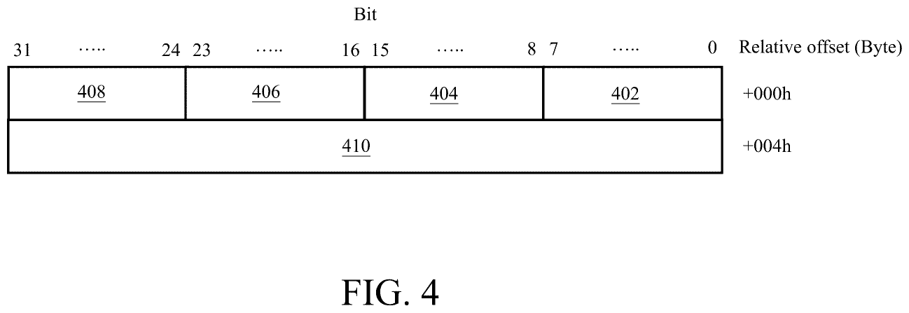

FIG. 3 is a diagram of a PCIe configuration space of a solid-state storage device according to an embodiment of the present disclosure. FIG. 4 is a diagram of a PCIe capability structure according to an embodiment of the present disclosure.

In some embodiments, the PCIe MAC layer 220 of the solid-state storage device 20 has a register file (not shown) to store the PCIe configuration space 221. The PCIe configuration space 221 may be, for example, represented by a PCIe configuration space 300 shown in FIG. 3. After PCIe links 16 and 17 between the host 10 and the solid-state storage device 20 are established, the host 10 reads settings of the PCIe configuration space 221 from the memory controller 200 through the PCIe bus 15, to know capability information of solid-state storage device 20, such as settings of supported capabilities, device identification, and power management. For convenience of description, the solid-state storage device 20 supports a vendor-specific capability, and the host 10 can send a configuration read packet with a specific address to the solid-state storage device 20 through link 16 to read a value of the average temperature information TA of the memory controller 200, the details of which will be described later.

For example, the PCIe configuration space 300 includes a PCI configuration space 312 and a PCIe extension configuration space 310, as shown in FIG. 3. The PCI configuration space 312 includes a configuration space header 302 compatible with a PCI 3.0 standard, configuration spaces 304 and 308, and a PCIe capability structure 306. It should be noted that a address offset range of each configuration space in FIG. 3 includes a lower limit, but does not include an upper limit. For example, the address offset range of the PCIe configuration space 300 is between 0 and 0xFFF (in hexadecimal). In addition, the address offset range of the configuration space header 302 is between 0 and 0x3F.

When the solid-state storage device 20 supports the vendor-specific capability, a status register in the configuration space header 302 associated with a capability list is set to 1, and a capability pointer 3021 in the configuration space header 302 records a start address offset of a specific PCIe capability structure (e.g., the PCIe capability structure 306). The specific PCIe capability structure may also include a next capability pointer to provide a start address offset of a next specific PCIe capability structure. The PCIe capability structure 306 is, for example, a memory space of 8 bytes, and its address offset range is between 0xF0 and 0xF7. For convenience of description, the capability pointer 3021 of the configuration space header 302 points to the PCIe capability structure 306 with the start address offset of 0xF0, that is, the address offset range of the PCIe capability structure 306 is between 0xF0 and 0xF7.

In some embodiments, the PCIe capability structure 306 may be represented as a PCIe capability structure 400 in FIG. 4, including fields 402 to 410. Fields 402, 404, 406, and 408 represent a capability ID, a next capability pointer, a capability length, and a type, respectively. In detail, after the host 10 completes reading the settings of the configuration space header 302, the host 10 sends a configuration read packet with an address 0xF0 based on the capability pointer 3021 in the configuration space header 302, to read double-word setting values starting from 0xF0 in the PCIe capability structure 306, that is, including the capability ID, the next capability pointer, the capability length, and the type, respectively shown as fields 402, 404, 406, and 408 in the PCIe capability structure 400 in FIG. 4. In some embodiments, the configuration read packet is, for example, a configuration read transaction layer packet defined in the PCIe protocol, but the present disclosure is not limited thereto.

For convenience of description, the values recorded in fields 402 and 406 are 0x9 and 0x4, respectively. When the value recorded in field 402 is 0x9, it indicates that the solid-state storage device 20 supports the vendor-specific capability, and in this case, the PCIe capability structure 400 can also be referred to as a vendor-specific capability structure. When the value recorded in field 406 is 0x4, it indicates that the length of the vendor-specific capability is 4 bytes. In addition, if the value recorded in field 404 is 0, it indicates that the capability structure 400 does not point to other PCIe capability structures. If the set value recorded in field 404 is not 0, it indicates that the PCIe capability structure 400 points to a next PCIe capability structure with a value recorded in field 404 as the start address offset. Therefore, the host 10 may send a configuration read packet with the address of the value to the solid-state storage device 20, to read a setting value of the next PCIe capability structure.

Therefore, after the host 10 checks the setting values stored in fields 402, 404, and 406 to determine that the solid-state storage device 20 supports the vendor-specific capability and its the capability length, and whether the vendor-specific capability structure points to a next PCIe capability structure, the host 10 rechecks the setting value stored in field 408 to determine the type of the vendor-specific capability supported by the solid-state storage device 20. In this case, when the setting value stored in field 408 is equal to a specific value (e.g., 0x2), the host 10 may determine that the vendor-specific capability supported by the solid-state storage device 20 can report the average temperature information TA of the memory controller 200.

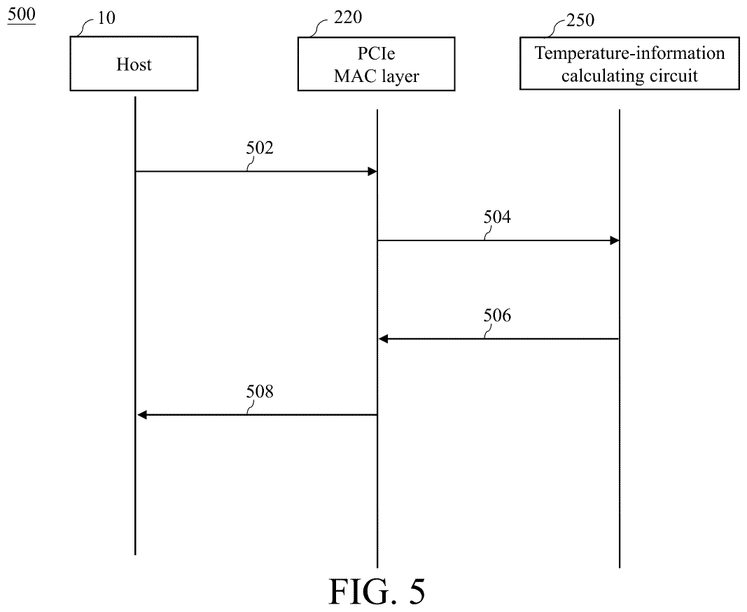

In some embodiments, the host 10 may know, from the setting value of the configuration space header 302, that the start address offset of the PCIe capability structure 306 is 0xF0, and obtain a double-word setting value starting from the start address offset 0xF0 of the PCIe capability structure 306, that is, 4 bytes (including fields 402 to 408) starting from +000h in FIG. 4. For example, the capability ID stored in field 402 is equal to 0x9, the capability length stored in field 406 is equal to 0x4, and the type stored in field 408 is equal to 0x2. Therefore, the host 10 may know that the solid-state storage device 20 supports the vendor-specific capability for reporting the average temperature information TA of the memory controller 200, and the PCIe capability structure 306 records a 4-byte value (e.g., stored in register 222 corresponding to field 410 of the PCIe capability structure 400) of the average temperature information TA. The average temperature information TA is, for example, a double-word setting value (e.g., four bytes starting from +004h in FIG. 4) starting from 0xF4. The operation procedure performed by the host 10 to obtain the average temperature information TA of the memory controller 200 can be referred to FIG. 5.

In step 502, the host 10 sends a configuration read packet with a specific address to the solid-state storage device 20. For example, the specific address is 0xF4, that is, the start address offset of the average temperature information TA of the PCIe capability structure 306.

In step 504, in response to the configuration read packet, the PCIe MAC layer 220 sends the request signal REQ to the temperature-information calculating circuit 250. For example, the request signal REQ is used to notify the temperature-information calculating circuit 250 to load the currently calculated average temperature information TA of the memory controller 200 into register 222 of the PCIe media access control layer 220. Register 222, for example, corresponds to field 410 of the PCIe capability structure 400.

In step 506, the temperature-information calculating circuit 250 loads the currently calculated average temperature information TA of the memory controller 200 into register 222.

In step 508, the PCIe MAC layer 220 packages the average temperature information TA stored in register 222 into data completion packet, and transmits the data completion packet to the host 10. The data completion packet is, for example, a completion with data transaction layer packet defined in the PCIe standard.

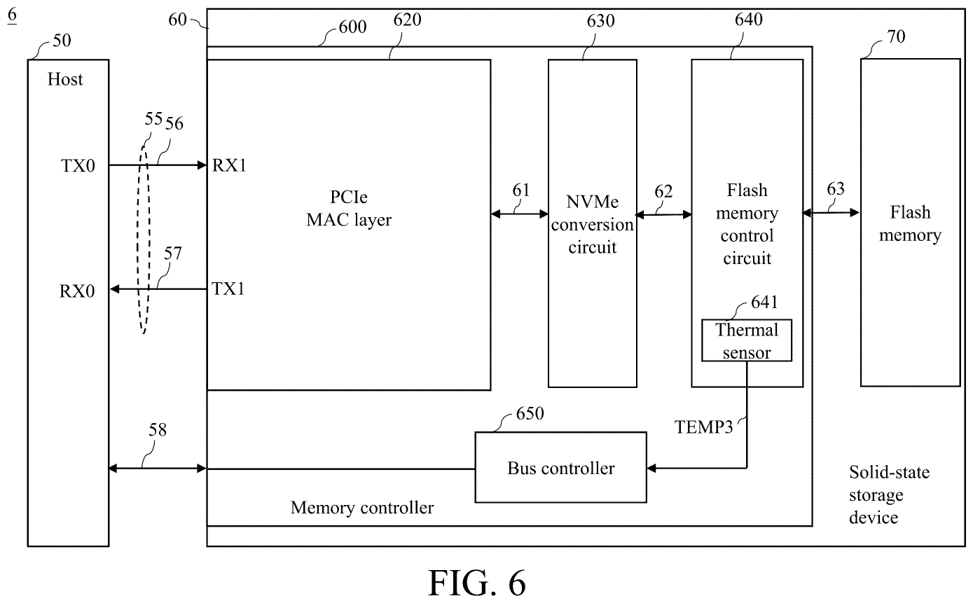

FIG. 6 is a block diagram of a computer system according to another embodiment of the present disclosure.

A computer system 6 in FIG. 6 is similar to the computer system 1 in FIG. 1, with the difference being that a solid-state storage device 600 of the computer system 6 is not equipped with a thermal sensor in its PCIe physical layer (not shown, included in a PCIe media access control layer 620). Instead, a bus controller 650 transmits temperature information TEMP3 of the flash memory control circuit 640 detected by the thermal sensor 641 to host 50 in real time through bus 58, rather than through PCIe bus 55. In some embodiments, bus 58 may be referred to as a sideband bus, and the communication protocol of bus 58 is different from that of PCIe bus 55, such as a Serial Peripheral Interface (SPI), an Inter-Integrated Circuit (I2C), etc., but the present disclosure is not limited thereto.

However, in the computer system 6, both the host 50 and memory controller 60 require separate transmission interfaces and related control circuits (e.g., bus controller 650) for bus 58, which increases design complexity and manufacturing costs. When either host 50 or the memory controller 60 has a damaged transmission interface or the control circuit related to the bus 58, the host 50 is unable to obtain the temperature information TEMP3 of the flash memory control circuit 640 (or the solid-state storage device 20). In addition, transmitting the temperature information TEMP3 of the flash memory control circuit 640 to host 50 in real time through bus 58 may cause host 50 to misjudge that the instantaneous temperature of the flash memory control circuit 640 is too high and immediately take relevant cooling measures, thereby affecting the performance of the solid-state storage device 600.

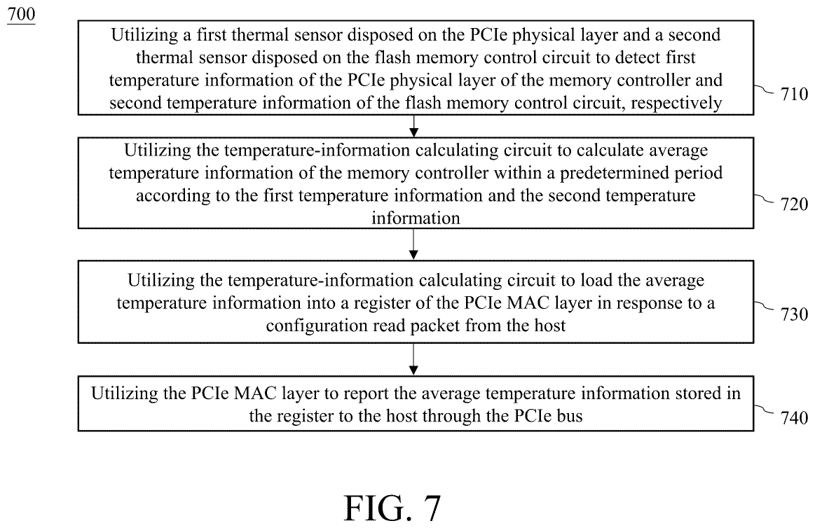

FIG. 7 is a flowchart of a method for monitoring temperature information of a solid-state storage device according to an embodiment of the present disclosure. Refer to FIG. 1 and FIG. 7 together.

Step 710: utilizing a first thermal sensor and a second thermal sensor to detect first temperature information of a PCIe physical layer and second temperature information of a flash memory control circuit, respectively. For example, the first thermal sensor and the second thermal sensor are, for example, the thermal sensor 211 disposed on the PCIe physical layer 210 and the thermal sensor 241 disposed in the flash memory control circuit 240, respectively. Additionally, the first temperature information and the second temperature information correspond to the temperature information TEMP1 and TEMP2 shown in FIG. 1, respectively.

Step 720: utilizing the temperature-information calculating circuit 250 to calculate average temperature information TA of the memory controller 200 within a predetermined period according to the first temperature information and the second temperature information. For example, the temperature information TEMP1 detected by the thermal sensor 211 and the temperature information TEMP2 detected by the thermal sensor 241 may be merged into temperature information TEMP, e.g., TEMP=(TEMP1, TEMP2). In addition, the temperature-information calculating circuit 250 may calculate, according to a clock period of a clock signal CLK, a sampling period signal SP, and a number of D flip flops 2501 to 250N, average temperature information within the predetermined period as the average temperature information TA of the memory controller 200, the details of which can be referred to the embodiment of FIG. 2B.

Step 730: utilizing the temperature-information calculating circuit 250 to load the average temperature information TA into the register 222 of the PCIe media access control layer 220 in response to a configuration read packet from the host 10. For example, step 730 can be divided into the following steps: utilizing the PCIe MAC layer 220 to send a request signal REQ to the temperature-information calculating circuit 250 in response to the configuration read packet from the host 10; and utilizing the temperature-information calculating circuit 250 to load the average temperature information TA into the register 222 of the PCIe media access control layer 220 in response to the request signal REQ. The request signal REQ is used to notify the temperature-information calculating circuit 250 to load the currently calculated average temperature information TA of the memory controller 200 into the register 222. The register 222, for example, corresponds to field 410 of the PCIe capability structure 400.

Step 740: utilizing the PCIe MAC layer 220 to report the average temperature information TA stored in the register 222 to the host 10 through the PCIe bus 15. For example, the PCIe MAC layer 220 packages the average temperature information TA stored in the register 222 into a data completion packet, and transmits the data completion packet to the host 10. The data completion packet is, for example, a completion with data transaction layer packet defined in the PCIe standard.

In view of the above, the memory controller, the solid-state storage device, and the method for monitoring temperature information of a solid-state storage device provided in the present disclosure are capable of storing temperature information of different elements detected by one or more thermal sensors in the memory controller within the predetermined period using the delay chain of the D flip flops within the temperature-information calculating circuit, and the sampling period can be adjusted with the design of the sampling period signal. In addition, the average temperature information of the memory controller calculated by the temperature-information calculating circuit can be stored in the register of a vendor-specific capability structure of the PCIe configuration space, and the host can obtain the average temperature information from the memory controller through the PCIe bus using the configuration read packet of the PCIe protocol. This design allows the memory controller to report its average temperature information within the predetermined period to the host through the PCIe bus, which not only prevents the host from making incorrect judgments and taking cooling measures that restrict the performance of the solid-state storage device but also eliminates the need to use other buses other than the PCIe bus to report the average temperature information to the host, thereby increasing the efficiency of the computer system and reducing the complexity and cost of design and maintenance.

Although the present disclosure is described above with preferred embodiments, the preferred embodiments are not intended to limit the scope of the present disclosure. Any person of ordinary skill in the art may make variations and modifications without departing from the spirit and scope of the present disclosure. The protection scope of the present disclosure should be subject to the appended claims.

What is claimed is:

1. A memory controller, comprising:
a Peripheral Component Interconnect Express (PCIe) physical layer, configured to electrically connect the memory controller to a host through a PCIe bus, the PCIe physical layer comprising a first thermal sensor, configured to detect first temperature information of the PCIe physical layer;
a PCIe media access control (MAC) layer, electrically connected to the PCIe physical layer, and configured to convert an access command from the host into a PCIe signal;
a Non-Volatile Memory Express (NVMe) conversion circuit, configured to convert the PCIe signal from the PCIe media access control layer into an NVMe signal;
a flash memory control circuit, configured to control data access of a flash memory according to the NVMe signal, the flash memory control circuit comprising a second thermal sensor, configured to detect second temperature information of the flash memory control circuit; and
a temperature-information calculating circuit, configured to calculate average temperature information of the memory controller within a predetermined period according to the first temperature information and the second temperature information, wherein
in response to a configuration read packet from the host, the temperature-information calculating circuit loads the average temperature information into a register of the PCIe media access control layer, and the PCIe MAC layer reports the average temperature information stored in the register to the host through the PCIe bus.

2. The memory controller according to claim 1, wherein the temperature-information calculating circuit is further configured to merge the first temperature information and the second temperature information into third temperature information, and calculate an average value of the third temperature information according to a clock signal of the memory controller and a sampling period signal, to obtain the average temperature information.

3. The memory controller according to claim 2, wherein the temperature-information calculating circuit comprises:
N D flip flops, connected in series to form a delay chain, to receive the third temperature information, wherein N is a positive integer, and a width of the sampling period signal is N bits;
N AND gates, each AND gate comprising: a first input terminal, connected to a data output terminal of the corresponding D flip flop, and a second input terminal, receiving the corresponding bit of the sampling period signal to generate a corresponding temperature signal;
an adder, summing up the corresponding temperature signals generated by the AND gates to obtain a sum value; and
a divider, dividing the sum value by a valid number to obtain the average temperature information.

4. The memory controller according to claim 3, wherein the predetermined period is N clock cycles of the clock signal.

5. The memory controller according to claim 3, wherein the valid number is a number of bits that are equal to 1 in the sampling period signal.

6. The memory controller according to claim 5, wherein in response to the configuration read packet, the PCIe media access control layer is further configured to send a request signal to the temperature-information calculating circuit, and in response to the request signal, the temperature-information calculating circuit further loads the average temperature information into the register of the PCIe media access control layer.

7. The memory controller according to claim 6, wherein the average temperature information comprises a first average value of the first temperature information within the predetermined period and a second average value of the second temperature information within the predetermined period.

8. The memory controller according to claim 1, wherein a PCIe configuration space of the PCIe media access control layer comprises a PCIe capability structure configured to define that the memory controller supports a vendor-specific capability for reporting the average temperature information, and the PCIe capability structure comprises the register.

9. The memory controller according to claim 8, wherein in response to a specific address of the configuration read packet pointing to the register, the temperature-information calculating circuit loads the average temperature information into the register, and the PCIe media access control layer packages the average temperature information stored in the register into a data completion packet, and reports the data completion packet to the host through the PCIe bus.

10. The memory controller according to claim 9, wherein the configuration read packet is a configuration read transaction layer packet in the PCIe protocol, and the data completion packet is a completion with data transaction layer packet in the PCIe protocol.

11. A method for monitoring temperature information of a solid-state storage device, wherein the solid-state storage device is electrically connected to a host through a Peripheral Component Interconnect Express (PCIe) bus, and a memory controller of the solid-state storage device comprises a PCIe physical layer, a PCIe media access control (MAC) layer, a flash memory control circuit, and a temperature-information calculating circuit, the method comprising:
utilizing a first thermal sensor disposed on the PCIe physical layer and a second thermal sensor disposed on the flash memory control circuit to detect first temperature information of the PCIe physical layer of the memory controller and second temperature information of the flash memory control circuit, respectively;
utilizing the temperature-information calculating circuit to calculate average temperature information of the memory controller within a predetermined period according to the first temperature information and the second temperature information;
utilizing the temperature-information calculating circuit to load the average temperature information into a register of the PCIe MAC layer in response to a configuration read packet from the host; and
utilizing the PCIe MAC layer to report the average temperature information stored in the register to the host through the PCIe bus.

12. The method according to claim 11, further comprising:
utilizing the temperature-information calculating circuit to merge the first temperature information and the second temperature information into third temperature information, and to calculate an average value of the third temperature information according to a clock signal of the memory controller and a sampling period signal, to obtain the average temperature information.

13. The method according to claim 12, further comprising:
receiving the third temperature information by using a delay chain formed by N D flip flops, wherein N is a positive integer, and a width of the sampling period signal is N bits;
selecting corresponding third temperature information on the delay chain according to each valid bit of the sampling period signal to generate a temperature signal;
summing up the temperature signals corresponding to the valid bits to obtain a sum value; and
dividing the sum value by a valid number of the sampling period signal to obtain the average temperature information.

14. The method according to claim 13, wherein the predetermined period is N clock cycles of the clock signal, and the valid number is a number of bits that are equal to 1 in the sampling period signal.

15. The method according to claim 14, wherein the step of utilizing the temperature-information calculating circuit to load the average temperature information into the register of the PCIe media access control layerin response to a configuration read packet comprises:
utilizing the PCIe MAC layer to send a request signal to the temperature-information calculating circuit in response to the configuration read packet; and
utilizing the temperature-information calculating circuit to load the average temperature information into the register of the PCIe media access control layer in response to the request signal.

16. The method according to claim 15, wherein the average temperature information comprises a first average value of the first temperature information within the predetermined period and a second average value of the second temperature information within the predetermined period.

17. The method according to claim 11, wherein a PCIe configuration space of the PCIe MAC layer comprises a PCIe capability structure configured to define that the memory supports a vendor-specific capability for reporting the average temperature information, and the PCIe capability structure comprises the register.

18. The method according to claim 17, further comprising:
utilizing the temperature-information calculating circuit to load the average temperature information into the register by using the temperature-information calculating circuit in response to a specific address of the configuration read packet pointing to the register; and
utilizing the PCIe MAC layer to package the average temperature information stored in the register into a data completion packet, and to report the data completion packet to the host through the PCIe bus.

19. The method according to claim 18, wherein the configuration read packet is a configuration read transaction layer packet in the PCIe protocol, and the data completion packet is a completion with data transaction layer packet in the PCIe protocol.

20. A solid-state storage device, comprising:
a flash memory; and
a memory controller, electrically connected to the flash memory, the memory controller comprising:
a Peripheral Component Interconnect Express (PCIe) physical layer, configured to be electrically connected to a host through a PCIe bus, the PCIe physical layer comprising a first thermal sensor, configured to detect first temperature information of the PCIe physical layer;
a PCIe media access control (MAC) layer, electrically connected to the PCIe physical layer, and configured to convert an access command from the host into a PCIe signal;
a Non-Volatile Memory Express (NVMe) conversion circuit,
configured to convert the PCIe signal from the PCIe media access control layer into an NVMe signal;
a flash memory control circuit, configured to control data access of the flash memory according to the NVMe signal; and
a temperature-information calculating circuit, configured to calculate average temperature information of the memory controller within the predetermined period according to the first temperature information and the second temperature information, wherein
in response to a configuration read packet from the host, the temperature-information calculating circuit loads the average temperature information into a register of the PCIe media access control layer, and the PCIe MAC layer reports the average temperature information stored in the register to the host through the PCIe bus.
